(19) United States
(12) Patent Application Publication
(10) Pub. No.: US 2011/0138857 A1
(43) Pub. Date: Jun. 16, 2011

(54) BONDED GLASS CUTTING METHOD, PACKAGE MANUFACTURING METHOD, PACKAGE, PIEZOELECTRIC VIBRATOR, OSCILLATOR, ELECTRONIC DEVICE, AND ATOMIC TIMEPIECE

(76) Inventors: Masashi Numata, Chiba-shi (JP); Junya Fukuda, Chiba-shi (JP)

(21) Appl. No.: 12/965,214

(22) Filed: Dec. 10, 2010

(30) Foreign Application Priority Data
Dec. 10, 2009 (JP) 2009-280899

(51) Int. Cl. C03B 33/037; C03B 33/02; C03B 33/10

(52) U.S. Cl. 65/28; 65/112; 65/29.18; 65/60.1

(57) ABSTRACT

To provide a bonded glass cutting method whereby it is possible to suppress an occurrence of a crush or chipping when bonded glass is cut, and cut the bonded glass into pieces of a predetermined size, a package manufacturing method, a package, a piezoelectric vibrator, an oscillator, an electronic device, and an atomic timepiece. A bonded glass cutting method includes a scribing step, which irradiates a lid substrate wafer with a laser beam with a wavelength absorbed by a wafer bonded body along outlines, thus forming scribe lines on the lid substrate wafer, and a breaking step which, by cutting the wafer bonded body by applying a fracture stress to the scribe lines, dices the wafer bonded body into a plurality of piezoelectric vibrators, wherein a cutting step is carried out in a condition in which the wafer bonded body is placed on silicon rubber, and an outside end face of the lid substrate wafer is caused to face the silicon rubber.

### RELATED APPLICATIONS

This application claims priority under 35 U.S.C. §119 to Japanese Patent Application No. 2009-280899 filed on Dec. 10, 2009, the entire content of which is hereby incorporated by reference.

### BACKGROUND OF THE INVENTION

1. Technical Field

The present invention relates to a bonded glass cutting method, a package manufacturing method, a package, a piezoelectric vibrator, an oscillator, an electronic device, and an atomic timepiece.

2. Related Art

In recent years, a piezoelectric vibrator (a package) utilizing quartz or the like as a time source, a timing source of a control signal or the like, a reference signal source, or the like, has been used in a portable telephone or a portable information terminal device. Various piezoelectric vibrators of this kind are known but, as one of them, a surface mounted (SMD) piezoelectric vibrator is known. This kind of piezoelectric vibrator includes, for example, a base substrate and lid substrate bonded to each other, a cavity formed between the two substrates, and a piezoelectric vibrating piece (an electronic part) stored in a condition in which it is airtightly sealed within the cavity.

Continuing, a brief description will be given of a method of manufacturing the piezoelectric vibrator.

Cavity recesses are firstly formed in a lid substrate wafer, while the piezoelectric vibrating pieces are mounted on a base substrate wafer, after which the two wafers are anodically bonded via a bonding layer (a bonding material), thus forming a wafer bonded body wherein a plurality of packages are formed in horizontal and vertical directions of the wafers. Subsequently, the wafer bonded body is cut in the horizontal and vertical directions along predetermined cutting lines, thereby dicing the wafer bonded body into a plurality of piezoelectric vibrators.

Herein, for example, Japanese Patent No. 3,577,492 discloses a technology for cutting a comparatively large glass substrate used for a liquid crystal panel, or the like, into separate pieces. Specifically, scribe lines (grooves) are formed on a surface of the glass substrate along the predetermined cutting lines of the glass substrate and, after the glass substrate is chemically treated, a mechanical or thermal stress is applied to the scribe lines, thus cutting the glass substrate into separate pieces.

Also, as a method of cutting the glass substrate by applying a mechanical stress thereto, after the glass substrate on which the scribe lines are formed is set on a metal stage, a cutting blade made of silicon rubber, called Anco, is dropped under its own weight or dropped under control along the scribe lines. By this means, a load is applied along the scribe lines, thus cutting the glass substrate.

However, as the piezoelectric vibrator is a minute electronic part, a high cutting accuracy is required to dice the wafer bonded body into a plurality of piezoelectric vibrators of a desired size. However, when a cutting of the wafer bonded body is carried out on the metal stage, as heretofore described, there are the following kinds of problem.

Firstly, on a load being applied by the cutting blade being dropped onto the scribe lines of the wafer bonded body, a large load also acts on a region other than the scribe lines. As a result of this, there is a fear of the wafer bonded body, when cut, being crushed into pieces.

Also, there is also a problem in that the wafer bonded body is cracked from a position other than the scribe lines, and the wafer bonded body breaks obliquely. As a result of this, in the worst case, there is a problem in that the cavity communicates with the exterior, thus preventing the airtightness in the cavity from being maintained.

Furthermore, when the wafer bonded body is diced into a plurality of piezoelectric vibrators, it is necessary to cut the wafer bonded body in a reticular pattern (horizontal and vertical directions) but, at this time, there is also a fear that, in particular, portions in which the cutting lines intersect each other, that is, portions forming angular portions of piezoelectric vibrators, come into contact with each other, and are chipped (a chipping occurs). In this case, the chipping causes the wafer bonded body to become likely to break, and cut surfaces to become coarse too.

For this kind of reason, in a manufacture of a minute electronic part such as the piezoelectric vibrator, as it is difficult to carry out the cutting on the metal stage, there is a problem in that the number of good items produced from one wafer bonded body decreases, and yield decreases.

### SUMMARY OF THE INVENTION

Therein, the invention, having been contrived bearing in mind the heretofore described problems, provides a bonded glass cutting method whereby it is possible to suppress an occurrence of a crush or chipping when cutting bonded glass, and cut the bonded glass into pieces of a desired size, a package manufacturing method, a package, a piezoelectric vibrator, an oscillator, an electronic device, and an atomic timepiece.

In order to solve the heretofore described problems, the invention provides the following measures.

A bonded glass cutting method according to a first aspect of the invention that cuts bonded glass, wherein bonding surfaces of a plurality of glass substrates are bonded together via a bonding material, along predetermined cutting lines includes a groove formation step which irradiates the bonded glass with a laser beam with a wavelength absorbed by the bonded glass along the predetermined cutting lines, thus forming grooves on one surface of the bonded glass along the predetermined cutting lines; and a cutting step which applies a fracture stress by pressing a cutting blade against the other surface of the bonded glass along the predetermined cutting lines, thereby cutting the bonded glass along the predetermined cutting lines, wherein the cutting step is carried out in a condition in which the bonded glass is placed on an elastic sheet, and the one surface of the bonded glass is caused to face the elastic sheet.

According to this configuration, by pressing the cutting blade against the other surface of the bonded glass along the predetermined cutting lines, the elastic sheet is elastically deformed, and the bonded glass undergoes a slight flexural deformation in such a way as to curve toward the elastic sheet following the elastic deformation of the elastic sheet. Because of this, the fracture stress applied to the bonded glass becomes likely to concentrate on the bottom apexes of the grooves.

As a result of this, when a fracture stress is applied to the bonded glass, with the bottom apexes of the grooves as a starting point at which a crack occurs, the crack becomes likely to grow from the one surface of the bonded glass toward the other surface, and the bonded glass is cut in such a way as to break along the grooves.

Consequently, it is possible to cut the bonded glass more smoothly and easily along the predetermined cutting lines. For this reason, it is possible to suppress an occurrence of a crush, as well as suppressing an occurrence of a chipping, and obtain good cut surfaces with no trace of residual stress. Because of this, it is possible to cut the bonded glass to a desired size. As a result of this, it is possible to increase the number of bonded glass pieces produced from one piece of bonded glass as good items, and it is possible to improve yield.

Also, the elastic sheet is made of a transparent material and, in the cutting step, the positions of the grooves are detected by an imaging unit from the side opposite the bonded glass across the elastic sheet, and a position adjustment of the edge of the cutting blade on the bonded glass is carried out based on a result of the detection by the imaging unit.

According to this configuration, as it is possible, by adjusting the positions of the grooves and cutting blade, to reliably apply a fracture stress along the predetermined cutting lines, it is possible to cut the bonded glass more smoothly and easily.

Also, in the cutting step, the bonded glass is cut in a condition in which a protecting sheet is attached to the one surface side of the bonded glass.

According to this configuration, as the protecting sheet is interposed between the bonded glass and elastic sheet, in the event that minute grit and dust is generated when the bonded glass is cut, or the like, it is possible to capture grit and dust, or the like, by means of the protecting sheet. For this reason, it is possible to prevent an attachment of grit and dust, or the like, to the surface of the elastic sheet, and always maintain the surface of the elastic sheet in a good condition with no attachment of grit and dust thereto.

As a result of this, it is possible to prevent the bonded glass placed on the elastic sheet from being damaged by abutting against grit and dust, or the like. Also, as it is possible to place the bonded glass on the elastic sheet in a condition in which it is always closely attached thereto, it is possible to prevent a backlash or the like when the bonded glass is placed thereon, and reliably cut the bonded glass in the thickness direction.

Also, in the cutting step, the bonded glass is cut in a condition in which an adhesive sheet is attached to the other surface of the bonded glass, and the latter stage of the cutting step includes an expanding step which, by stretching the adhesive sheet in a surface direction of the bonded glass, widens the space between a plurality of bonded glass pieces into which the bonded glass is cut.

According to this configuration, as it is possible to separate adjacent bonded glass pieces from one another in the expanding step, it becomes easy to recognize diced bonded glass pieces when the bonded glass pieces are removed from the adhesive sheet after the expanding step (a recognition accuracy is improved). As a result of this, it is possible to easily remove each bonded glass piece.

Also, it is possible, when removing a bonded glass piece from the adhesive sheet after the expanding step, to prevent a contact thereof with an adjacent bonded glass piece, or the like, prevent an occurrence of a chipping due to the contact between the bonded glass pieces, or the like, and prevent a breaking of the bonded glass pieces. Therefore, it is possible to increase the number of bonded glass pieces produced from one piece of bonded glass as good items, and it is possible to improve yield.

Also, the adhesive sheet has a sheet material and an ultraviolet curable adhesive layer which causes the sheet material to adhere to the bonded glass, and the latter stage of the expanding step includes an ultraviolet irradiation step which irradiates the adhesive layer of the adhesive sheet with ultraviolet, thus reducing the adhesive power of the adhesive layer.

According to this configuration, by reducing the adhesive power of the adhesive layer, it is possible to make it easy to remove the diced bonded glass pieces.

Also, a package manufacturing method according to a second aspect of the invention is a method which, using the bonded glass cutting method of the first aspect of the invention, manufactures a package including a cavity, within which an electronic part can be enclosed, inside the bonded glass, wherein in the cutting step, the bonded glass is cut along the predetermined cutting lines defining the formation regions of a plurality of the packages.

According to this configuration, by manufacturing the package using the bonded glass cutting method of the first aspect of the invention, it is possible to suppress an occurrence of a crush or chipping of a wafer bonded body, and prevent a breaking of the package. Therefore, it is possible to increase the number of bonded glass pieces produced from one piece of bonded glass as good items, and it is possible to improve yield.

Also, a package according to a third aspect of the invention, which is formed using the bonded glass cutting method of the first aspect of the invention, includes a cavity, within which an electronic part can be enclosed, inside the bonded glass, wherein the one surface of a bonded glass piece into which the bonded glass is cut has a chamfer made by the grooves being fractured.

According to this configuration, when a cut package is removed, even in the event that a tool for removing the package comes into contact with an angular portion of the package, it is possible to suppress an occurrence of a chipping due to the contact, meaning that it does not happen that the chipping causes a breaking of the package. Because of this, it is possible to secure the airtightness in the cavity, and it is possible to provide a highly reliable package.

As the chamfers can be automatically formed by cutting the bonded glass along the grooves (predetermined cutting lines) after forming the grooves by means of a laser, it is not necessary to form a chamfer on each cut package as a separate process. As a result of this, it is possible to suppress an increase in cost, as well as improving a working efficiency, in comparison with a case in which the chamfers are formed by the separate process.

Also, with a piezoelectric vibrator according to a fourth aspect of the invention, a piezoelectric vibrating piece is airtightly sealed within the cavity of the package of the third aspect of the invention.

According to this configuration, it is possible to secure the airtightness in the cavity, and it is possible to provide a highly reliable piezoelectric vibrator with an excellent vibration characteristic.

Also, with an oscillator according to a fifth aspect of the invention, the piezoelectric vibrator of the fourth aspect of the invention is electrically connected to an integrated circuit as a resonator.

Also, with an electronic device according to a sixth aspect of the invention, the piezoelectric vibrator of the fourth aspect of the invention is electrically connected to a timer.

Also, with an atomic timepiece according to a seventh aspect of the invention, the piezoelectric vibrator of the fourth aspect of the invention is electrically connected to a filtering unit.

In the oscillator, electronic device, and atomic timepiece according to the fifth to seventh aspects of the invention, as they include the piezoelectric vibrator, it is possible to provide products which are as highly reliable as the piezoelectric vibrator.

According to the bonded glass cutting method of the first aspect of the invention, it is possible to cut the bonded glass smoothly and easily along the predetermined cutting lines. For this reason, it is possible to suppress an occurrence of a crush, as well as suppressing an occurrence of a chipping, and obtain good cut surfaces with no trace of residual stress. Because of this, it is possible to cut the bonded glass to a desired size. As a result of this, it is possible to increase the number of bonded glass pieces produced from one piece of bonded glass as good items, and it is possible to improve yield.

Also, according to the package manufacturing method of the second aspect of the invention, by forming the package using the bonded glass cutting method of the first aspect of the invention, it is possible to prevent a crush of the wafer bonded body, as well as suppressing an occurrence of a chipping due to a contact between adjacent packages, and prevent a breaking of the package. Therefore, it is possible to increase the number of packages produced from one piece of bonded glass as good items, and it is possible to improve yield.

Also, according to the package of the third aspect of the invention, as the package is formed using the bonded glass cutting method of the first aspect of the invention, it is possible to secure the airtightness in the cavity, and it is possible to provide a highly reliable package.

Also, according to the piezoelectric vibrator of the fourth aspect of the invention, it is possible to secure the airtightness in the cavity, and provide a highly reliable piezoelectric vibrator with an excellent vibration characteristic.

In the oscillator, electronic device, and atomic timepiece according to the fifth to seventh aspects of the invention, as they include the piezoelectric vibrator, it is possible to provide products which are as highly reliable as the piezoelectric vibrator.

### BRIEF DESCRIPTION OF THE DRAWINGS

FIG. 1 is an external perspective view showing one embodiment of a piezoelectric vibrator according to the invention;

FIG. 2, being an internal configuration diagram of the piezoelectric vibrator shown in FIG. 1, is a top view of a piezoelectric vibrating piece in a condition in which a lid substrate is removed;

FIG. 3 is a sectional view of the piezoelectric vibrator along line A-A shown in FIG. 2;

FIG. 4 is an exploded perspective view of the piezoelectric vibrator shown in FIG. 1;

FIG. 5 is a flowchart showing a flow when manufacturing the piezoelectric vibrator shown in FIG. 1;

FIG. 6, being a diagram showing one process when manufacturing the piezoelectric vibrator in accordance with the flowchart shown in FIG. 5, is an exploded perspective view of a wafer bonded body wherein a base substrate wafer and a lid substrate wafer are anodically bonded in a condition in which the piezoelectric vibrators are stored in cavities;

FIG. 7 is a flowchart showing a flow of a dicing step;

FIG. 8, being a diagram for illustrating the dicing step, is a sectional view showing a condition in which the wafer bonded body is held in a magazine;

FIG. 9, being a diagram for illustrating the dicing step, is a sectional view showing the condition in which the wafer bonded body is held in the magazine;

FIG. 10, being a diagram for illustrating the dicing step, is a sectional view showing the condition in which the wafer bonded body is held in the magazine;

FIG. 11, being a diagram for illustrating the dicing step, is a sectional view showing the condition in which the wafer bonded body is held in the magazine;

FIG. 12, being a diagram for illustrating the dicing step, is a sectional view showing the condition in which the wafer bonded body is held in the magazine;

FIG. 13, being a diagram for illustrating the dicing step, is a sectional view showing the condition in which the wafer bonded body is held in the magazine;

FIG. 14, being an illustration for illustrating a trimming step, is a plan view of the base substrate wafer showing a condition in which the lid substrate wafer of the wafer bonded body is removed;

FIG. 15 is a side view of the piezoelectric vibrator in a case in which a breaking is carried out using 1 mm thick silicon rubber;

FIG. 16 is a plan view of the base substrate wafer side of the wafer bonded body in a case in which a breaking is carried out using 1 mm thick silicon rubber;

FIG. 17 is a side view of the piezoelectric vibrator in a case in which a breaking is carried out using 2 mm thick silicon rubber;

FIG. 18 is a configuration diagram showing one embodiment of an oscillator according to the invention;

FIG. 19 is a configuration diagram showing one embodiment of an electronic device according to the invention; and

FIG. 20 is a configuration diagram showing one embodiment of an atomic timepiece according to the invention.

### DESCRIPTION OF THE PREFERRED EMBODIMENTS

Hereafter, based on the drawings, a description will be given of embodiments of the invention.

### Piezoelectric Vibrator

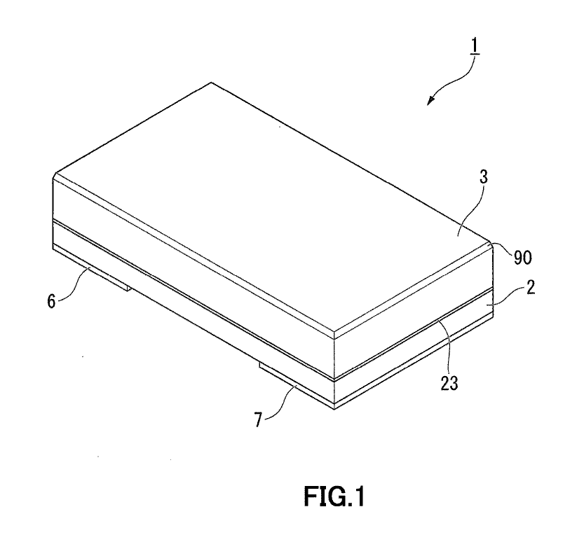

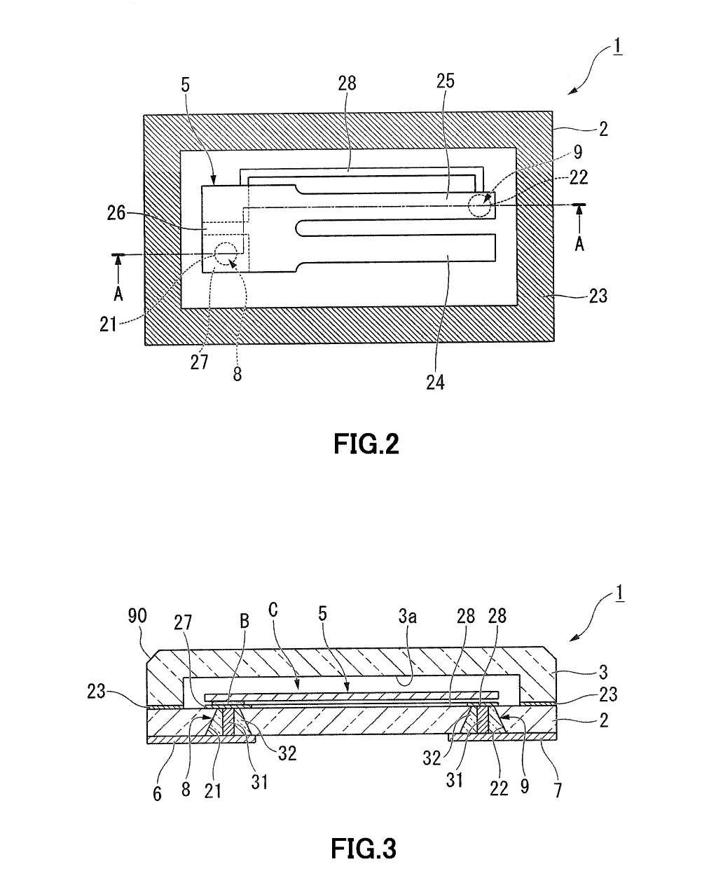

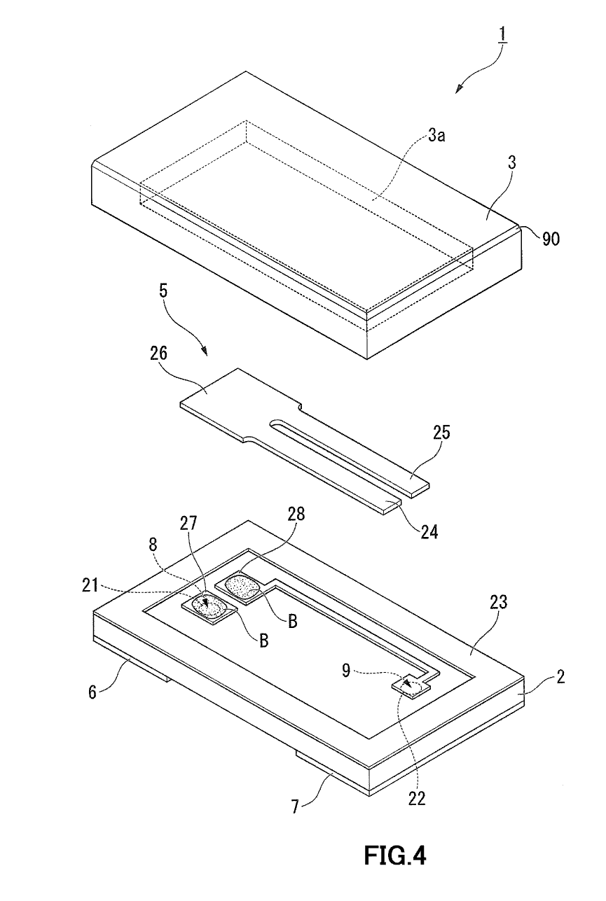

FIG. 1 is an external perspective view of a piezoelectric vibrator according to an embodiment, and FIG. 2, being an internal configuration diagram of the piezoelectric vibrator, is a top view of a piezoelectric vibrating piece in a condition in which a lid substrate is removed. Also, FIG. 3 is a sectional view of the piezoelectric vibrator taken along line A-A shown in FIG. 2, and FIG. 4 is an exploded perspective view of the piezoelectric vibrator.

As shown in FIGS. 1 to 4, a piezoelectric vibrator 1, being formed into a two-layered box by a base substrate 2 and a lid substrate 3, is a surface mounted piezoelectric vibrator 1, in a cavity C inside which a piezoelectric vibrating piece 5 is stored. Then, the piezoelectric vibrating piece 5, and external electrodes 6 and 7 disposed on the outer side of the base substrate 2, are electrically connected by a pair of through electrodes 8 and 9 which pass through the base substrate 2.

The base substrate 2, being a transparent insulating substrate made of a glass material, for example, soda-lime glass, is formed into a plate. A pair of through holes 21 and 22 in which are formed the pair of through electrodes 8 and 9 are formed in the base substrate 2. The through holes 21 and 22 form a tapered shape in cross-section wherein their diameter decreases gradually from the outside end face (the lower surface in FIG. 3) of the base substrate 2 toward the inside end face (the upper surface in FIG. 3).

The lid substrate 3, being a transparent insulating substrate made of a glass material, for example, soda-lime glass, is formed into a plate of a size such that it can be superimposed on the base substrate 2. Then, a rectangular recess 3a in which is stored the piezoelectric vibrating piece 5 is formed on a bonding surface side of the lid substrate 3 to which the base substrate 2 is bonded.

The recess 3a forms the cavity C storing the piezoelectric vibrating piece 5 when the base substrate 2 and led substrate 3 are laid one on top of the other. Then, the lid substrate 3 is anodically bonded to the base substrate 2 via a bonding layer 23, to be described hereafter, in a condition in which the recess 3a is caused to face the base substrate 2 side. A chamfer 90 wherein an angular portion of the lid substrate 3 is chamfered at a time of a scribing step, to be described hereafter, in a piezoelectric vibrator 1 manufacturing process is formed at the upper peripheral edge of the lid substrate 3.

The piezoelectric vibrating piece 5, being a tuning fork shaped piezoelectric vibrating piece made of a piezoelectric material such as quartz, lithium tantalite, or lithium niobate, vibrates when a predetermined voltage is applied.

The piezoelectric vibrating piece 5, being a tuning fork shaped one formed of a pair of vibrating arms 24 and 25 disposed in parallel and a base 26 which fixes the proximal portions of the vibrating arms 24 and 25 integrally, has excitation electrodes, formed of an unshown pair of a first excitation electrode and second excitation electrode which cause the vibrating arms 24 and 25 to vibrate, and a pair of mount electrodes, which electrically connect the first excitation electrode and second excitation electrode, and drawing electrodes 27 and 28, to be described hereafter, (the excitation and mount electrodes are not shown) on the outer surfaces of the pair of vibrating arms 24 and 25.

The piezoelectric vibrating piece 5 configured in this way is bump bonded to the drawing electrodes 27 and 28 formed on the inside end face of the base substrate 2, utilizing bumps B made of gold or the like, as shown in FIGS. 3 and 4. More specifically, the first excitation electrode of the piezoelectric vibrating piece 5 is bump bonded to the one drawing electrode 27 via the one mount electrode and the one bump B, and the second excitation electrode is bump bonded to the other drawing electrode 28 via the other mount electrode and the other bump B. Because of this, as well as the piezoelectric vibrating piece 5 being supported in a condition in which it is suspended above the inside end face of the base substrate 2, the mount electrodes and drawing electrodes 27 and 28 are placed in a condition in which the former electrodes are electrically connected one to either of the latter electrodes.

Then, the bonding layer 23 which, being used for an anodic bonding, is made of a conductive material (for example, aluminum) is formed on the inside end face side (the bonding surface side to which the lid substrate 3 is bonded). The bonding layer 23, being formed to a film thickness of, for example, around 3000 A to 5000 A, is formed along the peripheral edge of the base substrate 2 in such a way as to surround the recess 3a formed in the lid substrate 3. Then, the base substrate 2 and lid substrate 3 are anodically bonded via the bonding layer 23 in a condition in which the recess 3a is caused to face the bonding surface side of the base substrate 2.

Also, the external electrodes 6 and 7, being disposed at either longitudinal end of the outside end face of the base substrate 2, are electrically connected to the piezoelectric vibrating piece 5 via the corresponding through electrodes 8 and 9, and corresponding drawing electrodes 27 and 28. More specifically, the one external electrode 6 is electrically connected to the one mount electrode of the piezoelectric vibrating piece 5 via the one through electrode 8 and the one drawing electrode 27. Also, the other external electrode 7 is electrically connected to the other mount electrode of the piezoelectric vibrating piece 5 via the other through electrode 9 and the other drawing electrode 28.

The through electrodes 8 and 9, each of which is formed of a cylindrical body 32 and a core portion 31 which are integrally fixed to the through holes 21 and 22 by sintering, as well as completely closing the through holes 21 and 22, maintaining the airtightness in the cavity C, perform the role of bringing the external electrodes 6 and 7, and drawing electrodes 27 and 28, into electrical continuity. Specifically, the one through electrode 8 is positioned below the drawing electrode 27 between the external electrode 6 and base 26, and the other through electrode 9 is positioned below the drawing electrode 28 between the external electrode 7 and vibrating arm 25.

The cylindrical body 32 is one wherein a paste-like glass frit is sintered. The cylindrical body 32, both ends of which are flat, is formed into a cylinder whose thickness is approximately the same as that of the base substrate 2. Then, the core portion 31 is disposed in the center of the cylindrical body 32 in such a way as to pass through the central hole of the cylindrical body 32. Also, in the embodiment, the cylindrical bodies 32 are formed in such a way that the external shape thereof is conical (of a tapered shape in cross-section) so as to coincide with the shape of the through holes 21 and 22. Then, the cylindrical bodies 32, being sintered in a condition in which they are embedded in the through holes 21 and 22, are firmly fixed to the through holes 21 and 22.

The core portion 31, being a conductive core formed from a metallic material into a column, is formed so that both ends are flat, and the thickness is approximately the same as that of the base substrate 2, in the same way as with the cylindrical body 32.

The through electrodes 8 and 9 have electrical continuity secured through the conductive core portions 31.

When operating the piezoelectric vibrator 1 configured in this way, a predetermined drive voltage is applied to the external electrodes 6 and 7 formed on the base substrate 2. By this means, it is possible to cause a current to flow through each excitation electrode of the piezoelectric vibrating piece 5, and it is possible to cause the pair of vibrating arms 24 and 25 to vibrate at a predetermined frequency in directions toward and away from each other. Then, it is possible, by utilizing the vibration of the pair of vibrating arms 24 and 25, to utilize the piezoelectric vibrator 1 as a time source, a timing source of a control signal, a reference signal source, or the like.

### Piezoelectric Vibrator Manufacturing Method

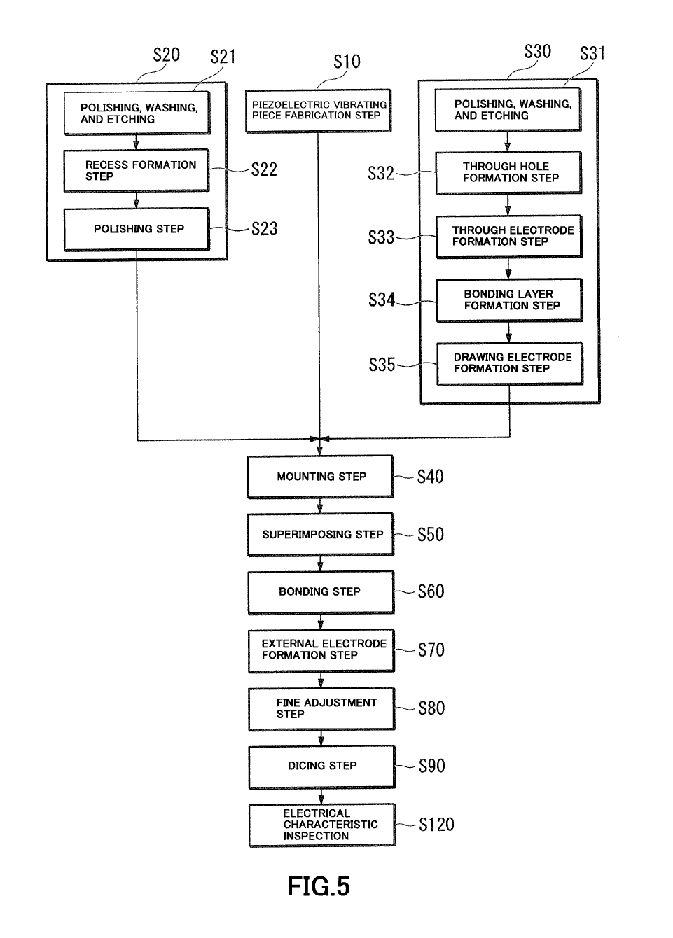

Next, a description will be given, while referring to the flowchart shown in FIG. 5, of a method of manufacturing the heretofore described piezoelectric vibrator.

Firstly, as shown in FIG. 5, a piezoelectric vibrating piece fabrication step is carried out to fabricate the piezoelectric vibrating piece 5 shown in FIGS. 1 to 4 (S10). Also, after the piezoelectric vibrating piece 5 has been fabricated, a coarse adjustment of a resonance frequency is carried out. A fine adjustment which adjusts the resonance frequency to a higher degree of accuracy is carried out after a mounting.

### First Wafer Fabrication Step

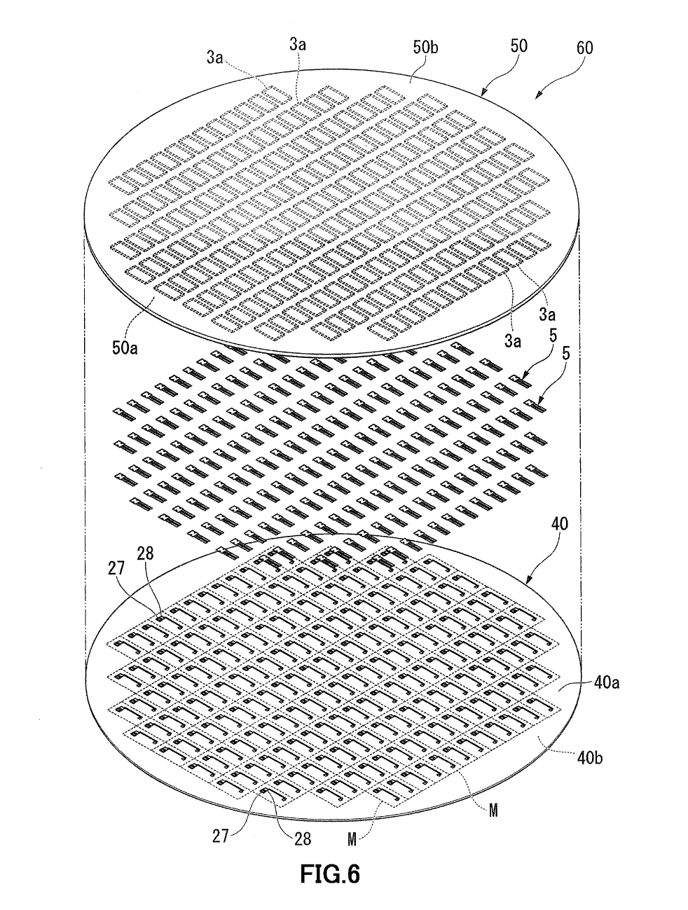

FIG. 6 is an exploded perspective view of a wafer bonded body wherein a base substrate wafer and a lid substrate wafer are anodically bonded in a condition in which the piezoelectric vibrating pieces are stored in the cavities.

Next, as shown in FIGS. 5 and 6, a first wafer fabrication step is carried out which fabricates a lid substrate wafer 50, which is to form the lid substrate 3 later, as far as a condition immediately before an anodic bonding is carried out (S20). Specifically, after soda-lime glass has been polished to a predetermined thickness and washed, the disk-shaped lid substrate wafer 50 from which an affected outermost layer is removed by etching, or the like, is formed (S21). Next, a recess formation step is carried out which forms a plurality of the cavity C recesses 3a in horizontal and vertical directions by etching, or the like, in an inside end face 50a (the lower surface in FIG. 6) of the lid substrate wafer 50 (S22).

Next, in order to secure the airtightness with a base substrate wafer 40, to be described hereafter, a polishing step (S23) which polishes at least the inside end face 50a side of the lid substrate wafer 50, which forms a bonding surface to be bonded to the base substrate wafer 40, is carried out, thus processing the inside end face 50a into a mirror finish. By the above means, the first wafer fabrication step (S20) finishes.

### Second Wafer Fabrication Step

Next, a second wafer fabrication step which fabricates the base substrate wafer 40, which is to form the base substrate 2 later, as far as a condition immediately before an anodic bonding is carried out is carried out at a timing simultaneous with, or a timing before and after, the first wafer fabrication step (S30). Firstly, after soda-lime glass has been polished to a predetermined thickness and washed, a disk-shaped base substrate wafer 40 from which an affected outermost layer is removed by etching, or the like, is formed (S31). Next, a through hole formation step is carried out which forms a plurality of the pairs of through holes 21 and 22 for disposing the pairs of through electrodes 8 and 9 in the base substrate wafer 40 by means of, for example, a press working (S32). Specifically, after forming the recesses in the base substrate wafer 40 from an outside end face 40b thereof by a press working or the like, by polishing the base substrate wafer 40 from at least an inside end face 40a side thereof, it is possible to cause the recesses to pass through the base substrate wafer 40, and form the through holes 21 and 22.

Continuing, a through electrode formation step (S33) is carried out which forms the through electrodes 8 and 9 in the through holes 21 and 22 formed in the through hole formation step (S32). Because of this, the core portions 31 are held in the through holes 21 and 22 in a condition in which they are flush with both end faces 40a and 40b (the upper and lower surfaces in FIG. 6) of the base substrate wafer 40. By the above means, it is possible to form the through electrodes 8 and 9.

Next, as well as a bonding layer formation step being carried out which forms the bonding layer 23 by patterning a conductive material on the inside end face 40a of the base substrate wafer 40 (S34), a drawing electrode formation step is carried out (S35). The bonding layer 23 is formed in a region of the base substrate wafer 40 other than a cavity C forming region, that is, over the whole of a region bonded to the inside end face 50a of the lid substrate wafer 50. By so doing, the second wafer fabrication step (S30) finishes.

Next, the piezoelectric vibrating pieces 5 fabricated in the piezoelectric vibrating piece fabrication step (S10) are mounted via the bumps B made of gold, or the like, one on each of the pair of the drawing electrodes 27 and 28 of the base substrate wafer 40 fabricated in the second wafer fabrication step (S30) (S40). Then, a superimposing step is carried out wherein the base substrate wafer 40 and lid substrate wafer 50 fabricated in the heretofore described corresponding wafer 40 and 50 fabrication steps are laid one on top of the other (S50). Specifically, both wafers 40 and 50 are aligned in correct positions with an unshown reference mark or the like as an index. Because of this, the mounted piezoelectric vibrating piece 5 attains a condition in which it is stored in the cavity C surrounded by the recess 3a formed in the lid substrate wafer 50 and the base substrate wafer 40.

After the superimposing step, a bonding step is carried out which puts the two superimposed wafers 40 and 50 in an unshown anodic bonding device and, in a condition in which the outer peripheral portions of the wafers are clamped by an unshown holding mechanism, anodically bonds them by applying a predetermined voltage in a predetermined temperature atmosphere (S60). Specifically, the predetermined voltage is applied between the bonding layer 23 and lid substrate wafer 50. Then, an electrochemical reaction occurs in the interface between the bonding layer 23 and lid substrate wafer 50, and the two are attached firmly to each other and anodically bonded. Because of this, it is possible to seal the piezoelectric vibrating piece 5 within the cavity C, and it is possible to obtain the wafer bonded body 60 (for example, a thickness of around 0.4 mm to 0.9 mm) wherein the base substrate wafer 40 and lid substrate wafer 50 are bonded. Then, by anodically bonding both wafers 40 and 50 together, as in the embodiment, it is possible to prevent an aging deterioration, a misalignment due to an impact or the like, a warpage of the wafer bonded body 60, or the like, more than with a case in which both wafers 40 and 50 are bonded with an adhesive or the like, and bond both wafers 40 and 50 more firmly.

Subsequently, the pair of external electrodes 6 and 7 electrically connected to the pair of through electrodes 8 and 9 respectively are formed (S70), and the frequency of the piezoelectric vibrator 1 is finely adjusted (S80).

### Dicing Step

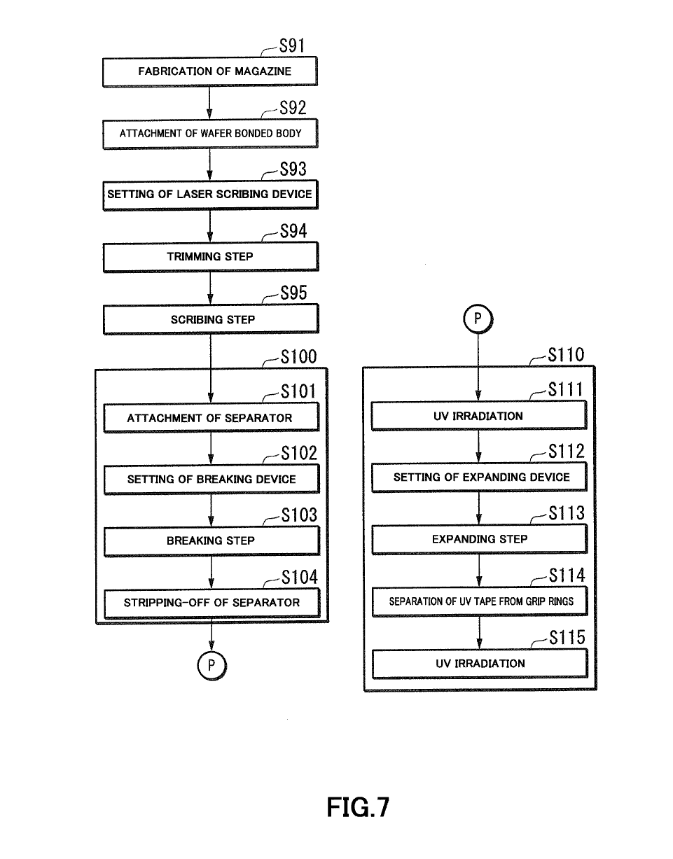

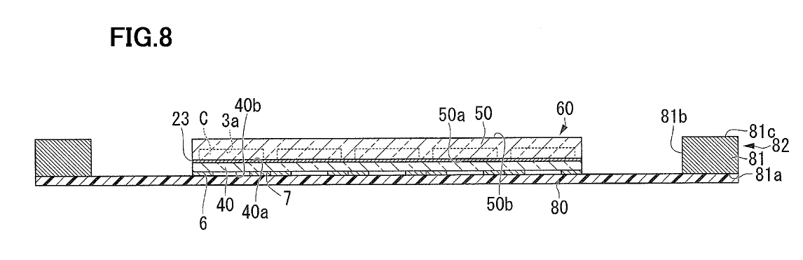

FIG. 7 is a flowchart showing a procedure of a wafer bonded body dicing step. Also, FIGS. 8 to 13, being sectional views showing a condition in which a wafer bonded body is held in a magazine, are process diagrams for illustrating the dicing step.

After the fine adjustment of the frequency, the dicing step is carried out which cuts the bonded wafer bonded body 60, wherein the two wafers are bonded, into dice (S90).

In the dicing step (S90), as shown in FIGS. 7 and 8, firstly, a magazine 82 for holding the wafer bonded body 60 is fabricated using a UV tape 80 and a ring frame 81 (S91). The ring frame 81, being a ring-shaped member formed so that the inner diameter thereof is larger than the diameter of the wafer bonded body 60, is formed so that the thickness (the axial length) is equivalent to that of the wafer bonded body 60. Also, the UV tape 80 is one wherein a sheet material made of polyolefin is coated with an ultraviolet curable resin, for example, acrylic pressure sensitive adhesive (an adhesive layer), and specifically, Denki Kagaku Kogyo's UHP-1525M3, Lintec's D510T, or the like, is suitably used therefor. Also, it is preferable to use a comparatively thick one for the UV tape 80, and specifically, it is preferable to use one whose thickness is around 160 μm or more and 180 μm or less. In the embodiment, for example, a UV tape 80 of around 175 μm is suitably used.

The magazine 82 can be fabricated by attaching the UV tape 80 to one surface 81a of the ring frame 81 in such a way as to close a through hole 81b. Then, the wafer bonded body 60 is attached to an adhesive surface of the UV tape 80 in a condition in which the central axis of the ring frame 81 and the central axis of the wafer bonded body 60 are aligned (S92). Specifically, the outside end face 40b side (external electrode side) of the base substrate wafer 40 is attached to the adhesive surface of the UV tape 80. Because of this, the wafer bonded body 60 attains a condition in which it is set in the through hole 81b of the ring frame 81. In this condition, the wafer bonded body 60 is conveyed to a laser scribing device (not shown) (S93).

FIG. 14, being an illustration for illustrating a trimming step, is a plan view of the base substrate wafer showing a condition in which the lid substrate wafer of the wafer bonded body is removed.

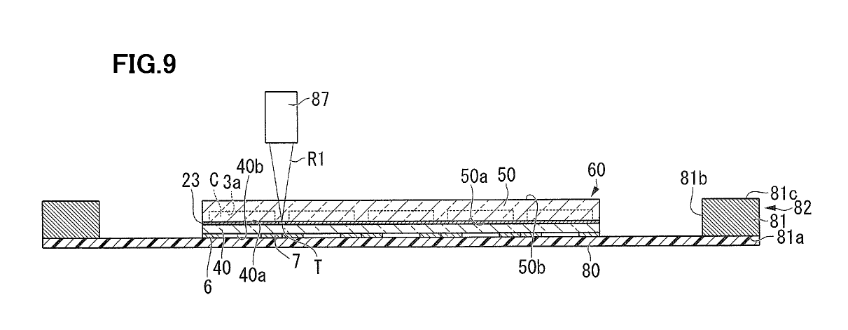

Herein, as shown in FIGS. 9 and 14, the trimming step is carried out which strips off the bonding layer 23 bonding the lid substrate wafer 50 and base substrate wafer 40 (S94). In the trimming step (S94), a region of the bonding layer irradiated with a laser beam R1 is melted using a laser which emits a light with a band of wavelength absorbed by the bonding layer 23, for example, a first laser 87 formed of a second harmonic laser with a wavelength of 532 nm. In this case, the laser beam R1 emitted from the first laser 87, after being reflected by a beam scanner (a galvanometer), is condensed via an Fθ lens. Then, the laser beam R1 and wafer bonded body 60 are moved parallel relative to each other while the wafer bonded body 60 is being irradiated with the condensed laser beam R1 from the outside end face (the other surface) 50b side of the lid substrate wafer 50. Specifically, a scanning with the first laser 87 is carried out over dividers between the individual cavities C, that is, along outlines (predetermined cutting lines) M (refer to FIG. 6) of the piezoelectric vibrators 1.

The spot diameter of the laser beam R1 in the trimming step (S94) is set to, for example, around 10 μm or more and 30 μm or less. Also, as other conditions of the trimming step (S94), for example, it is preferable that the average processing point power of the first laser 87 is set to 1.0 W, the frequency modulation to 20 kHz, and the scanning speed to around 200 mm/sec.

Because of this, by the bonding layer 23 on the outlines M being heated while absorbing the laser beam R1, the bonding layer 23 melts and contracts outwardly from the region (outlines M) irradiated with the laser beam R1. As a result of this, trimming lines T made by the bonding layer 23 being stripped off from the bonding surfaces are formed on the bonding surfaces (the inside end face 50a of the lid substrate wafer 50 and the inside end face 40a of the base substrate wafer 40) of both wafers 40 and 50.

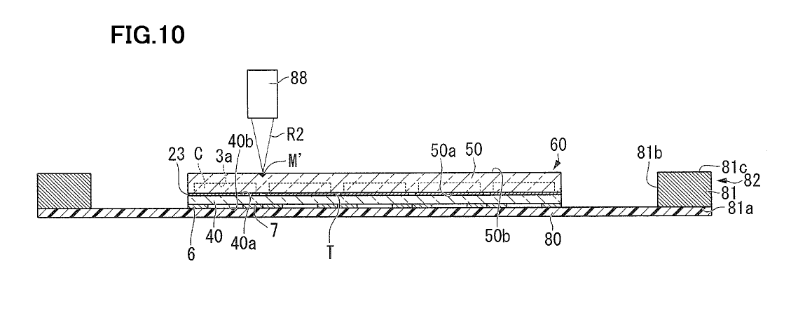

Next, as shown in FIG. 10, scribe lines M′ are formed on the wafer bonded body 60 by irradiating a superficial portion of the outside end face 50b of the lid substrate wafer 50 with a laser beam R2 (S95: a scribing step). In the scribing step (S95), a superficial portion of the lid substrate wafer 50 in the laser irradiation region is melted using a laser which emits a light with a band of wavelength absorbed by the lid substrate wafer 50 (soda-lime glass), for example, a second laser 88 formed of a UV-Deep laser with a wavelength of 266 nm. Specifically, in the same way as in the trimming step (S94), the second laser 88 and wafer bonded body 60 are moved parallel relative to each other, and a scanning with the second laser 88 is carried out along the outlines M of the piezoelectric vibrators 1. Then, the lid substrate wafer 50 melts by the superficial portion of the lid substrate wafer 50 being heated while absorbing the laser beam R2, thus forming the V-shaped groove-like scribe lines M′. In the way heretofore described, a scanning with the first laser 87 and second laser 88 is carried out along the outline M of each piezoelectric vibrator 1. Because of this, the trimming lines T and scribe lines M′ wherein the bonding layer 23 is stripped off are disposed in such a way as to be laid one on top of the other when the wafer bonded body 60 is seen from its thickness direction.

The scribe lines M′ of the embodiment are formed so that the width dimension is around 14 μm and the depth dimension is around 11 μm. It is preferable to set the ratio of the depth dimension D to the width dimension W to be the same. As other conditions of the scribing step (S95), for example, it is preferable that the processing point power of the second laser 88 is set to 250 mW to 600 mW, the pulse energy to 100 μJ, the processing threshold fluence to 30 J/(cm2·pulse), the scanning speed to 40 mm/sec to 60 mm/sec, the aperture to 10 mm, and the frequency to around 65 kHz.

Next, a cutting step is carried out which cuts the wafer bonded body 60 on which are formed the scribe lines M′ into separate piezoelectric vibrators 1 (S100).

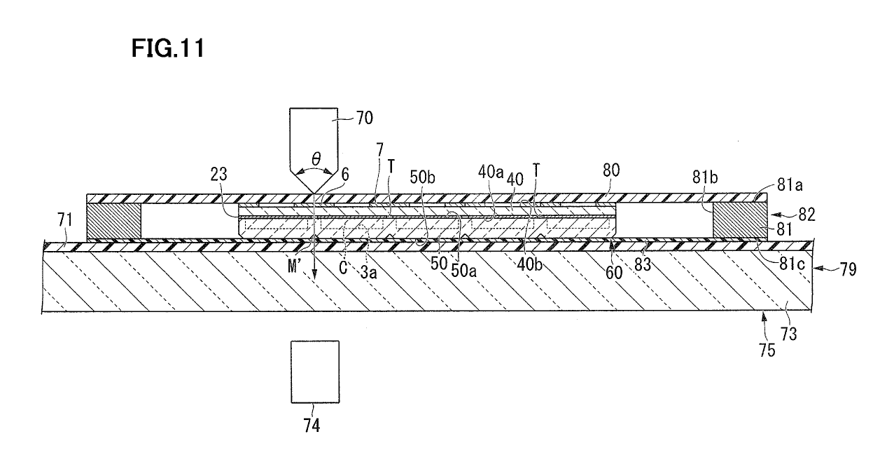

In the cutting step (S100), firstly, as shown in FIG. 11, a separator (a protecting sheet) 83 is attached to another surface 81c of the ring frame 81 in such a way as to close the through hole 81b (S101). The separator 83 is one for, in a breaking step (S103), protecting the outside end face 50b of the lid substrate wafer 50, as well as preventing minute grit and dust generated at a time of a breaking from flying into a breaking device 79, to be described hereafter, by closing the ring frame 81 by means of the UV tape 80 and separator 83. This kind of separator 83 is formed from, for example, a polyethylene terephthalate film (a so-called PET material) so that the thickness is 20 μm or more and 30 μm or less, and in the embodiment, a 25 μm thick separator 83 is used. When the thickness of the separator 83 is less than 20 μm, it is not preferable because there is a fear of the separator 83 being cut together with the wafer bonded body 60 in the breaking step (S103) to be described hereafter. Meanwhile, when the thickness of the separator 83 is more than 30 μm, it is not preferable because a fracture stress acting on the wafer bonded body 60 from the separator 83 is relieved by the separator 83, and the wafer bonded body 60 is not smoothly cut, so that there is a fear of the surface accuracy of cut surfaces decreasing.

Then, the wafer bonded body 60 is held in the through hole 81b of the ring frame 81 in a condition in which it is clamped by the UV tape 80 and separator 83. In this condition, the wafer bonded body 60 is conveyed into the breaking device 79 (S102).

The breaking device 79 includes a stage 75 for placing the wafer bonded body 60 on, a cutting blade 70 for cutting the wafer bonded body 60, and a CCD camera (an imaging unit) 74 disposed below the stage 75 (on the side opposite the wafer bonded body 60 placing surface). The stage 75 includes a base 73 (for example, 10 mm thick) made of a transparent material, such as silica glass, and silicon rubber (an elastic sheet) 71 disposed on the base 73. The silicon rubber 71, being made of a transparent material, is formed to have a thickness of, for example, around 2 mm. Also, the cutting blade 60 is formed so that the bladed portion is longer than the diameter of the wafer bonded body 60, and is formed so that the blade edge angle θ is, for example, around 60 degrees to 90 degrees.

In this case, the wafer bonded body 60 is set in the breaking device 79 in a condition in which the outside end face 50b (the one surface) of the lid substrate wafer 50 is caused to face the stage 75. That is, the wafer bonded body 60 is placed on the base 73 across the silicon rubber 71 and separator 83.

Then, the breaking step is carried out which applies a fracture stress to the wafer bonded body 60 set in the breaking device 79 (S103). In the breaking step (S103), firstly, a position adjustment is carried out in such a way that the cutting blade 70 is disposed on the scribe lines M′ (trimming lines T). Specifically, the positions of the scribe lines M′ on the lid substrate wafer 50 are detected by the CCD camera 74 disposed below the stage 75 and, based on a result of the detection, the cutting blade 70 is moved in a surface direction of the wafer bonded body 60. Because of this, it is possible to carry out a position adjustment of the cutting blade 70. Subsequently, the cutting blade 70 is moved (downward) in the thickness direction of the wafer bonded body 60, and the edge of the cutting blade 70 is pressed against the outside end face 40b of the base substrate wafer 40. Subsequently, the cutting blade 70 is moved a predetermined stroke (for example, around 50 μm) in such a way as to be thrust in the thickness direction of the wafer bonded body 60. At this time, a predetermined load (for example, 10 kg/inch) is applied to the wafer bonded body 60.

Because of this, a crack in the thickness direction occurs in the wafer bonded body 60, and the wafer bonded body 60 is cut in such a way as to break along the scribe lines M′ formed on the lid substrate wafer 50. At this time, with the breaking device 79 of the embodiment, as the wafer bonded body 60 is set on the silicon rubber 71 of the stage 75, by thrusting the cutting blade 70 into the wafer bonded body 60, the silicon rubber 71 is elastically deformed. Along with this, the wafer bonded body 60 undergoes a slight flexural deformation in such a way as to curve toward the stage 75 following a surface of the silicon rubber 71. Because of this, the fracture stress applied to the wafer bonded body 60 becomes likely to concentrate on the bottom apexes of the scribe lines M′. Furthermore, a load due to the cutting blade 70 acting on other than the contact point of the cutting blade 70 and wafer bonded body 60 escapes to (is absorbed or attenuated by) the silicon rubber 71.

Because of this, when a load is applied to the wafer bonded body 60, with the bottom apexes of the scribe lines M′ as a starting point at which a crack occurs, in the wafer bonded body 60, the crack becomes likely to grow in the thickness direction from the outside end face 50a of the lid substrate wafer 50 toward the outside end face 40b of the base substrate wafer 40. As a result of this, the wafer bonded body 60 is cut in such a way as to break along the grooves. Also, the fracture stress is a tensile stress occurring in directions away from the scribe lines M′ (in directions in which the individual piezoelectric vibrators 1 are separated from one another).

Herein, the inventor of the present application has carried out an examination in which, by changing the thickness of the silicon rubber 71 disposed on the base 73, the breaking step is carried out for each of the changed thicknesses, and the cut surfaces of the wafer bonded body 60 (the side surfaces of the piezoelectric vibrator 1) are observed. A 175 μm thick UV tape 80 is used in each breaking step, and conditions of the second laser 88 for forming the scribe lines M′ are such that the processing point power is set to 450 mW, the scanning speed to 40 mm/sec, the aperture to 10 mm, and the frequency to 65 kHz.

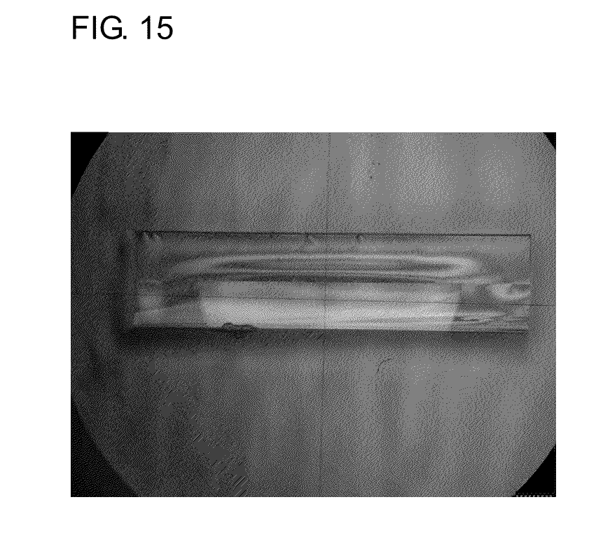

FIG. 15 is a side view of the piezoelectric vibrator 1 in a case in which a breaking has been carried out using 1 mm thick silicon rubber 71.

As shown in FIG. 15, it is found that, when a breaking is carried out using the 1 mm thick silicon rubber 71, a residual stress occurs in a plurality of places (for example, regions N1 to N3 in FIG. 15) on the side surfaces of the piezoelectric vibrator 1, and remains as strain. This is considered to be because, when the silicon rubber 71 is too thin, the fracture stress acting on the wafer bonded body 60 is not efficiently concentrated on the bottom apexes of the scribe lines M′, and a large load also acts on a portion other than the scribe lines M′, due to which the wafer bonded body 60 is not smoothly cut.

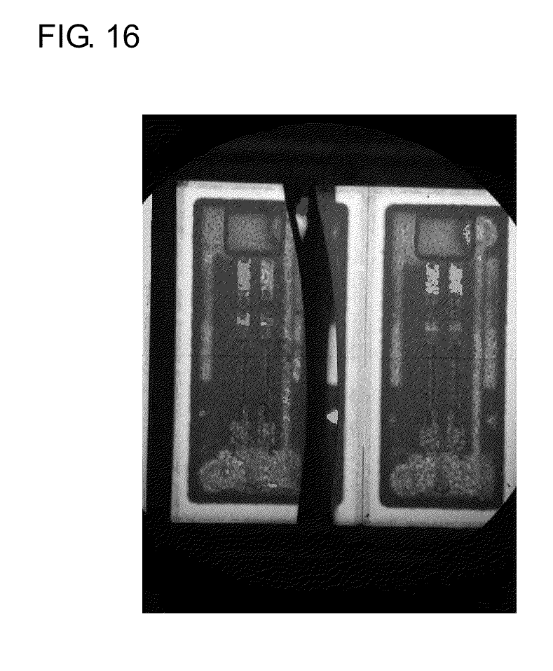

FIG. 16 is a plan view of the base substrate wafer 40 side of the wafer bonded body 60 in a case in which a breaking has been carried out using 1 mm thick silicon rubber 71.

Also, as shown in FIG. 16, when a breaking is carried out using the 1 mm thick silicon rubber 71, there has been a case in which the wafer bonded body 60 is cracked from a position differing from the scribe lines M′, and breaks obliquely (refer to reference character L in FIG. 16). When the silicon rubber 71 is 1 mm thick, it has also happened that a chipping occurs, in particular, due to portions in which the cutting lines intersect, that is, portions forming the angular portions of the piezoelectric vibrators 1, making contact with each other.

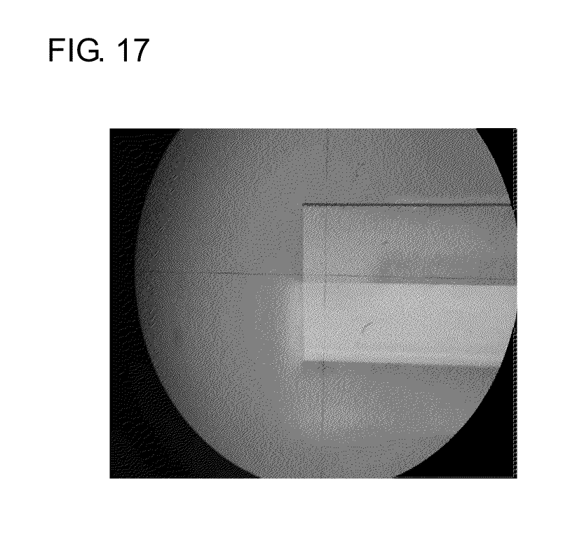

FIG. 17 is a side view of the piezoelectric vibrator 1 in a case in which a breaking has been carried out using 2 mm thick silicon rubber 71.

In response to the heretofore described result, when a breaking is carried out using the 2 mm thick silicon rubber 71, as in the embodiment, it is found that the side surfaces of the piezoelectric vibrator 1 have no trace of residual stress, and are formed as good surfaces, as shown in FIG. 17. In this case, it is found that little chipping occurs, either, in the angular portions or the like of the piezoelectric vibrators 1. This is considered to be because, as the fracture stress applied to the wafer bonded body 60 becomes likely to concentrate on the bottom apexes of the scribe lines M′, as well as a load due to the cutting blade 70 which acts on other than the contact point of the cutting blade 70 and wafer bonded body 60 escaping effectively to (being absorbed and relaxed by) the silicon rubber 71, as heretofore described, it is possible to obtain better cut surfaces.

Although not shown, when a breaking is carried out, in the same way, using 3 mm thick silicon rubber 71, a phenomenon has occurred in which the wafer bonded body 60 is crushed. This is because the 3 mm thick silicon rubber 71 has too high a cushioning property, and it is necessary, when cutting the wafer bonded body 60, to apply a comparatively large load thereto. Then, this is considered to be because the load also acts on a region other than the scribe lines M′, as a result of which the wafer bonded body 60, when cut, is crushed into pieces.

From the above result, it is preferable that the thickness of silicon rubber 71 used for the stage 75 of the breaking device 79 is 2 mm.

Then, returning to FIG. 11, by pressing the cutting blade 70 against each scribe line M′ by means of the heretofore described method, it is possible to separate the wafer bonded body 60 into individual packages for each outline M all at once. Subsequently, the separator 83 attached to the wafer bonded body 60 is stripped off (S104).

Next, a picking-up step for removing the diced piezoelectric vibrators 1 is carried out (S110). In the picking-up step (S110), firstly, the UV tape 80 of the magazine 82 is irradiated with ultraviolet, thus slightly reducing the adhesive power of the UV tape 80 (S111). In this condition, the wafer bonded body 60 is still in a condition in which it is attached to the UV tape 80.

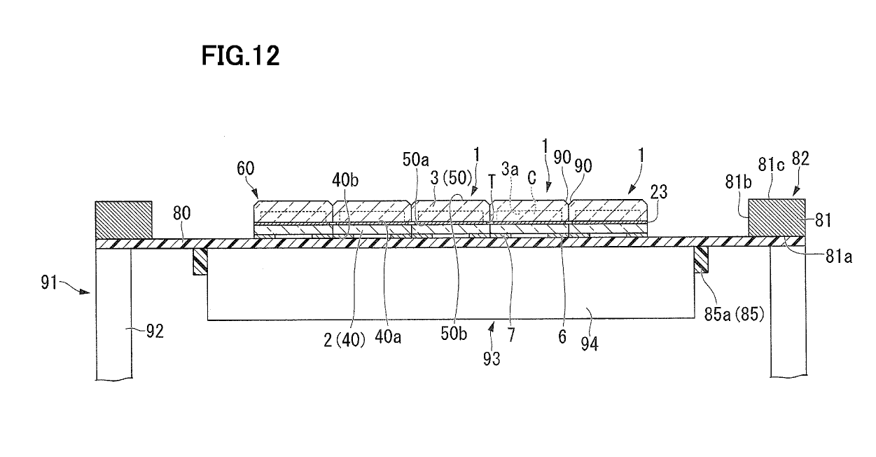

Next, in order to carry out an expanding step (S113), to be described hereafter, the wafer bonded body 60 is conveyed into an expanding device 91 (S112), as shown in FIG. 12. Therein, firstly, a description will be given of the expanding device 91.

The expanding device 91 includes an annular base ring 92, on which the ring frame 81 is set, and a disk-shaped heater panel 93 which, being disposed inside the base ring 92, is formed to be larger in diameter than the wafer bonded body 60. The heater panel 93, being one wherein a heat transfer type heater (not shown) is mounted on a base plate 94 on which the wafer bonded body 60 is set, is disposed in such a way that the central axis of the heater panel 93 coincides with the central axis of the base ring 92. Also, the heater panel 93 is configured so as to be movable in an axial direction by an unshown drive unit. Although not shown, the expanding device 91 also includes a holding member which clamps the ring frame 81 set on the base ring 92 between itself and the base ring 92.

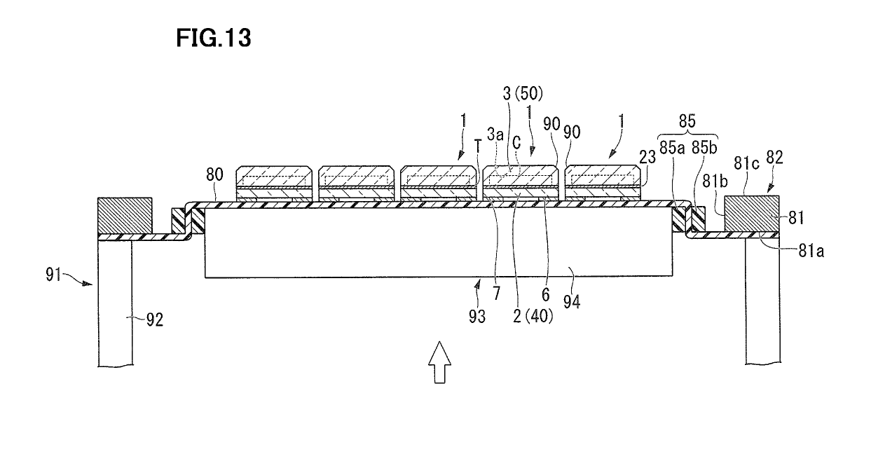

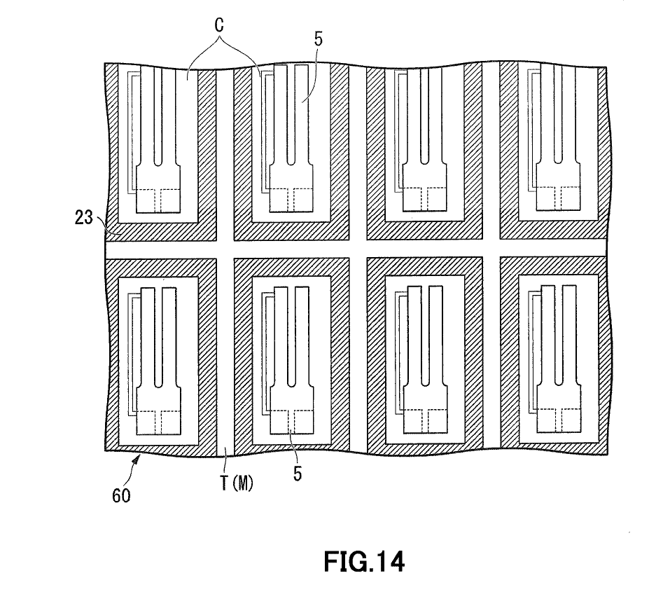

In order to carry out the expanding step (S113) using this kind of device, firstly, before the wafer bonded body 60 is set on the expanding device 91, an inside ring 85a, of grip rings 85, to be described hereafter, is set on the outer side of the heater panel 93. At this time, the inside ring 85a is fixed to the heater panel 93, and set in such a way as to move with the heater panel 93 when the heater panel 93 moves. The grip rings 85, being rings which, being made of a resin, are formed so that the inner diameter is larger than the outer diameter of the heater panel 93 and smaller than the inner diameter of the through hole 81b of the ring frame 81, are configured of the inside ring 85a and an outside ring 85b (refer to FIG. 13) formed so that the inner diameter is equivalent to the outer diameter of the inside ring 85a. That is, the inside ring 85a is arranged in such a way as to be fitted in the inner side of the outside ring 85b.

Subsequently, the wafer bonded body 60 fixed to the magazine 82 is set on the expanding device 91. At this time, the wafer bonded body 60 is set with the UV tape 80 side caused to face the heater panel 93 and base ring 92. Specifically, the wafer bonded body 60 is set on the expanding device 91 in a condition in which, as well as the outside end face 40b of the wafer bonded body 60 and the heater panel 93 being caused to face each other, the one surface 81a of the ring frame 81 and the base ring 92 are caused to face each other. Because of this, the wafer bonded body 60 is set on the heater panel 93 across the UV tape 80. Then, the ring frame 81 is clamped between the unshown holding member and base ring 92 by the holding member.

Next, the UV tape 80 is heated to 50° C. or more by a heater of the heater panel 93. By heating the UV tape 80 to 50° C. or more, the IN tape 80 is softened and becomes easy to stretch. Then, as shown in FIG. 13, in a condition in which the UV tape 80 is heated, the heater panel 93 is raised together with the inside ring 85a (refer to the arrow in FIG. 13). At this time, as the ring frame 81 is clamped between the base ring 92 and holding member, the UV tape 80 stretches toward a radial outer side of the wafer bonded body 60. Because of this, the piezoelectric vibrators 1 attached to the UV tape 80 are separated from one another, and the space between adjacent piezoelectric vibrators 1 widens. Then, in this condition, the outside ring 85b is set on the outer side of the inside ring 85a. Specifically, the inside ring 85a and outside ring 85b are fitted one in the other in a condition in which the UV tape 80 is sandwiched between them. Because of this, the UV tape 80 is held by the grip rings 85 in a condition in which it is stretched. Then, the ring frame 81 and grip rings 85 are separated by cutting the UV tape 80 outside the grip rings 85 (S114).

Subsequently, the adhesive power of the UV tape 80 is further reduced by irradiating the UV tape 80 again with ultraviolet (S115: an ultraviolet irradiation step). Because of this, the piezoelectric vibrators 1 are stripped off from the UV tape 80. Subsequently, the position of each piezoelectric vibrator 1 is checked by an image recognition or the like, and the piezoelectric vibrators 1 stripped off from the UV tape 80 are removed by sucking them with a nozzle or the like. In this way, by irradiating the UV tape 80 with ultraviolet and stripping off the piezoelectric vibrators 1 from the UV tape 80, it is possible to make it easy to remove the diced piezoelectric vibrators 1. In the embodiment, as the dicing is carried out along the scribe lines M′ on the lid substrate wafer 50 in the heretofore described breaking step (S103), the upper peripheral edges of the lid substrates 3 of the diced piezoelectric vibrators 1 are chamfered by the scribe lines M′, thus forming the chamfers 90 thereat.

By the above means, it is possible to manufacture a plurality of the two-layer structure type surface mounted piezoelectric vibrators 1 shown in FIG. 1, at one time, in each of which the piezoelectric vibrating piece 5 is sealed within the cavity C formed between the base substrate 2 and lid substrate 3 which are anodically bonded to each other.

Subsequently, as shown in FIG. 5, an internal electrical characteristic inspection is carried out (S120). That is, the resonance frequency, resonant resistance value, drive level characteristic (the drive level dependence of the resonance frequency and resonant resistance value), and the like, of the piezoelectric vibrating piece 5 are measured and checked. Also, an insulation resistance characteristic, or the like, is checked in addition. Then, finally, an appearance inspection of the piezoelectric vibrator 1 is carried out, and the size, quality, and the like, are checked for the last time. This concludes the manufacture of the piezoelectric vibrator 1.

In this way, in the embodiment, a configuration is adopted such as to carry out the breaking step in a condition in which the wafer bonded body 60 is set on the silicon rubber 71 of the stage 75.

According to the configuration, by pressing the cutting blade 70 against the wafer bonded body 60 along the scribe lines M′, the silicon rubber 71 is elastically deformed, and the wafer bonded body 60 undergoes a slight flexural deformation in such a way as to curve toward the silicon rubber 71 following the elastic deformation of the silicon rubber 71. Because of this, the fracture stress applied to the wafer bonded body 60 becomes likely to concentrate on the bottom apexes of the scribe lines M′.

As a result of this, when a fracture stress is applied to the wafer bonded body 60, with the bottom apexes of the scribe lines M′ as a starting point at which a crack occurs, the crack becomes likely to grow from the outside end face 50a of the lid substrate wafer 50 toward the outside end face 40b of the base substrate wafer 40 in the wafer bonded body 60, so that the wafer bonded body 60 is cut in such a way as to break along the scribe lines M′.

Consequently, it is possible to cut the wafer bonded body 60 more smoothly and easily along the scribe lines M′. For this reason, it is possible to suppress an occurrence of a crush, as well as suppressing an occurrence of a chipping, and obtain good cut surfaces with no trace of residual stress. Because of this, it is possible to cut the wafer bonded body 60 into piezoelectric vibrators 1 of a desired size. As a result of this, it is possible to increase the number of piezoelectric vibrators 1 produced from one wafer bonded body 60 as good items, and it is possible to improve yield.

Also, in the breaking step, by moving the cutting blade 70 in such a way as to thrust it in the thickness direction of the wafer bonded body 60 in a condition in which the leading end of the cutting blade 70 is placed in contact with the outside end face 40b of the base substrate wafer 40, it is possible to reliably apply a fracture stress along the scribe lines M′. For this reason, it is possible to accelerate a crack growth in the thickness direction of the wafer bonded body 60. Also, in comparison with a case of dropping the cutting blade onto the wafer bonded body, as heretofore known, it is easier to prevent an occurrence of a chipping due to a collision of the cutting blade and wafer bonded body 60. Consequently, it is possible to obtain better cut surfaces.

Furthermore, in the embodiment, a configuration is adopted such that, when bringing the cutting blade 70 into contact with the wafer bonded body 60, the position of the cutting blade is adjusted based on the positions of the scribed lines M′ detected by the CCD camera 74.

According to the configuration, by adjusting the positions of the scribe lines M′ and cutting blade 70, it is possible to reliably apply a fracture stress along the scribe lines M′, meaning that it is possible to cut the wafer bonded body 60 more smoothly and easily.

In the embodiment, as the separator 83 of the magazine 82 is interposed between the wafer bonded body 60 and silicon rubber 71, in the event that minute grit and dust, or the like, flies off when the wafer bonded body 60 is cut, it is possible to capture the grit and dust, or the like, by means of the silicon rubber 71.

As a result of this, it is possible to prevent the wafer bonded body 60 placed on the silicon rubber 71 from being damaged by abutting against grit and dust, or the like. Also, as it is possible to place the wafer bonded body 60 on the silicon rubber 71 in a condition in which it is always closely attached thereto, it is possible to prevent a backlash or the like when the wafer bonded body 60 is placed thereon, and reliably cut the wafer bonded body 60 in the thickness direction.

Moreover, in the embodiment, as it is possible, by carrying out the expanding step (S113) after dicing the wafer bonded body 60, to equally widen the space between individual adjacent piezoelectric vibrators 1, it is possible to reliably separate the adjacent piezoelectric vibrators 1 from one another. Consequently, as it becomes easy to recognize the diced piezoelectric vibrators 1 when the piezoelectric vibrators 1 are removed from the UV tape 80 after the expanding step (S113) (as the recognition accuracy is improved), it is possible to easily remove each piezoelectric vibrator 1.

Also, it is possible, when removing the piezoelectric vibrators 1 from the UV tape 80 after the expanding step (S113), to prevent a collision between adjacent piezoelectric vibrators 1, or the like, prevent an occurrence of a chipping due to a contact of one piezoelectric vibrator 1 with another, or the like, and prevent a breaking of the piezoelectric vibrators 1. Therefore, it is possible to increase the number of piezoelectric vibrators 1 produced from one wafer bonded body 60 as good items, and it is possible to improve yield.

Also, as there is no fear of the UV tape 80 causing a breaking or the like in the expanding step (S113), as heretofore described, the UV tape 80 used in the scribing step (S95) or the like can be used in the expanding step (S113), as it is, without being replaced. That is, as it is not necessary to carry out a UV tape 80 re-covering step or the like prior to the expanding step (S113), it is possible to prevent a reduction in manufacturing efficiency and an increase in manufacturing cost.

Meanwhile, as it is possible, by using the UV tape 80 formed to be 180 μm or less in thickness, to suppress a force needed to stretch the UV tape 80, it is possible to improve a manufacturing efficiency. Also, as it is possible to easily procure materials in the market, it is possible to reduce the cost of materials for the UV tape 80.

By stripping off the bonding layer 23 on the outlines M and forming the trimming lines T prior to the scribing step (S95), it is possible to accelerate a crack growth in the thickness direction of the wafer bonded body 60 at a time of breaking, as well as preventing a crack growth in the surface direction of the wafer bonded body 60.

Also, the lid substrate 3 of the piezoelectric vibrator 1 of the embodiment is configured so that the chamfer 90 is formed at the peripheral edge thereof.

According to this configuration, when the diced piezoelectric vibrators 1 are removed in the picking-up step (S110), even in the event that a tool for removing the piezoelectric vibrators 1 comes into contact with an angular portion of a piezoelectric vibrator 1, it is possible to suppress an occurrence of a chipping due to the contact. For this reason, it does not happen that the chipping causes a breaking of the piezoelectric vibrator 1.

Because of this, it is possible to secure the airtightness in the cavity C, and it is possible to provide a highly reliable piezoelectric vibrator 1 with an excellent vibration characteristic.

As the chamfers 90 can be automatically formed by cutting the wafer bonded body 1 along the scribe lines M′ after forming the scribe lines M′ by means of the second laser 88, it is not necessary to form the chamfer 90 on each cut piezoelectric vibrator 1. As a result of this, it is possible to suppress an increase in cost, and improve a working efficiency, in comparison with a case in which the chamfers are formed by a separate process.

### Oscillator

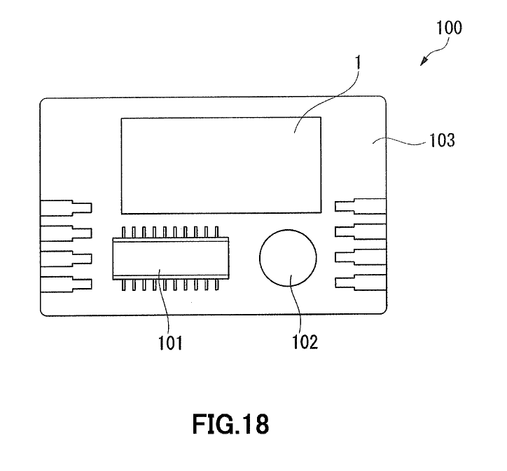

Next, a description will be given, while referring to FIG. 18, of one embodiment of an oscillator according to the invention.

An oscillator 100 of the embodiment is one wherein the piezoelectric vibrator 1 is configured as a resonator electrically connected to an integrated circuit 101, as shown in FIG. 18. The oscillator 100 includes a substrate 103 on which an electronic part 102 such as a capacitor is mounted. The integrated circuit 101 for the oscillator is mounted on the substrate 103, and the piezoelectric vibrator 1 is mounted in the vicinity of the integrated circuit 101. The electronic part 102, integrated circuit 101, and piezoelectric vibrator 1 are electrically connected to each other by an unshown wiring pattern. Each component is molded from an unshown resin.

In the oscillator 100 configured in this way, on applying a voltage to the piezoelectric vibrator 1, the piezoelectric vibrating piece 5 in the piezoelectric vibrator 1 vibrates. This vibration is converted into an electrical signal by a piezoelectric characteristic possessed by the piezoelectric vibrating piece 5, and input into the integrated circuit 101 as the electrical signal. The input electrical signal is subjected to various kinds of processing by the integrated circuit 101, and output as a frequency signal. Because of this, the piezoelectric vibrator 1 functions as the resonator.

Also, as the configuration of the integrated circuit 101, by selectively setting, for example, a real time clock (RTC) module in response to a request, apart from a timepiece single-function oscillator, or the like, it is possible to add functions of controlling an operate date or time of this instrument or an external instrument, and providing a time, a calendar, or the like.

As heretofore described, according to the oscillator 100 of the embodiment, as it includes the piezoelectric vibrator 1 heightened in quality, it is also possible to achieve a heightening in quality of the oscillator 100 itself in the same way. Furthermore, in addition to this, it is possible to obtain a stable and high-accuracy frequency over a long period.

### Electronic Device

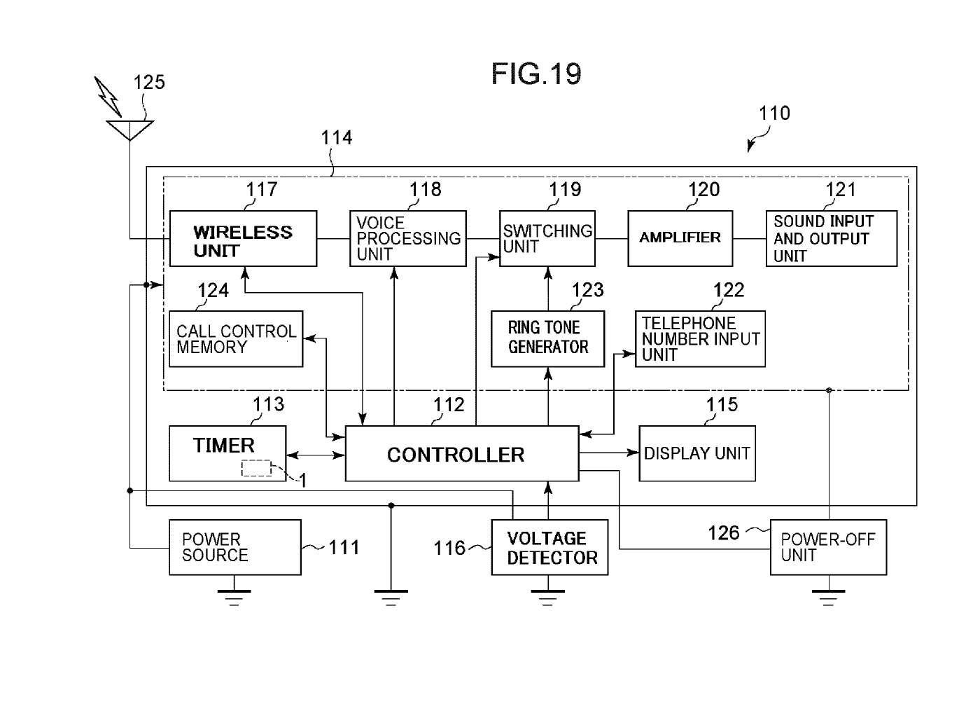

Next, a description will be given, with reference to FIG. 19, of one embodiment of an electronic device according to the invention. As the electronic device, a portable information device 110 having the piezoelectric vibrator 1 will be described as an example. Firstly, the portable information device 110, being one typified by, for example, a portable telephone, is one wherein a wrist watch in a heretofore known technology has been developed and improved. The portable information device 110 is such that the appearance is similar to a wrist watch, a liquid crystal display is disposed in a portion corresponding to a dial, and a current time or the like can be displayed on a screen thereof. Also, when it is utilized as a communication instrument, by removing it from a wrist, it is possible, with a speaker and microphone embedded in an inside portion of a band, to carry out communication the same as with the portable telephone of the heretofore known technology. However, in comparison with the heretofore known portable telephone, the portable information device 110 is dramatically reduced in size and weight.

Next, a description will be given of a configuration of the portable information device 110 of the embodiment. The portable information device 110 includes the piezoelectric vibrator 1 and a power source 111 for supplying power, as shown in FIG. 19. The power source 111 is formed of, for example, a lithium secondary battery. A controller 112, which carries out various kinds of control, a timer 113, which carries out a counting of time or the like, a communication unit 114, which carries out communication with the exterior, a display unit 115, which displays various kinds of information, and a voltage detection unit 116, which detects a voltage of each functional unit, are connected in parallel to the power source 111. Then, an arrangement is such that power is supplied to each functional unit by the power source 111.

The controller 112, by controlling each functional unit, carries out an operational control of the whole system, such as a transmission or reception of sound data, a measurement or display of a current time, or the like. Also, the controller 112 includes an ROM in which a program is written in advance, a CPU which reads and executes the program written in the ROM, an RAM used as a work area of the CPU, and the like.

The timer 113 includes an integrated circuit incorporating an oscillator circuit, a register circuit, a counter circuit, an interface circuit, and the like, and the piezoelectric vibrator 1. On a voltage being applied to the piezoelectric vibrator 1, the piezoelectric vibrating piece 5 vibrates, and the vibration is converted into an electrical signal by a piezoelectric characteristic possessed by quartz, and input into the oscillator circuit as the electrical signal. An output of the oscillator circuit is binarized, and counted by the register circuit and counter circuit. Then, a transmission and reception of a signal with the controller 112 is carried out via the interface circuit, and a current time, a current data, calendar information, or the like, is displayed on the display unit 115.

The communication unit 114, having the same function as the heretofore known portable telephone, includes a wireless unit 117, a sound processing unit 118, a switching unit 119, an amplifier 120, a sound input and output unit 121, a telephone number input unit 122, a ring tone generator 123, and a call control memory 124.

The wireless unit 117 carries out an exchange of various kinds of data, such as sound data, through a transmission and reception thereof with a base station via an antenna 125. The sound processing unit 118 codes and decodes a sound signal input from the wireless unit 117 or amplifier 120. The amplifier 120 amplifies the signal input from the sound processing unit 118 or sound input and output unit 121 up to a predetermined level. The sound input and output unit 121, being formed of a speaker, a microphone, and the like, amplifies a ring tone or a receiver sound, and collects sound.

Also, the ring tone generator 123 generates a ring tone in response to a call from the base station. Only at a time of an incoming call, by the switching unit 119 switching the amplifier 120 connected to the sound processing unit 118 to the ring tone generator 123, the ring tone generated in the ring tone generator 123 is output to the sound input and output unit 121 via the amplifier 120.

The call control memory 124 stores a program relating to an originating and incoming call control of communication. Also, the telephone number input unit 122 includes, for example, number keys of 0 to 9 and other keys, and a telephone number of the call destination input by depressing the number keys or the like.

When a voltage applied to each functional unit, such as the controller 112, by the power source 111 goes below a predetermined value, the voltage detector 116 detects this voltage drop, and notifies the controller 112. The predetermined voltage value at this time is a value set in advance as a minimum voltage needed to stably operate the communication unit 114, for example, around 3V. The controller 112 which has received the notice of the voltage drop from the voltage detector 116 prohibits the operation of the wireless unit 117, sound processing unit 118, switching unit 119, and ring tone generator 123. In particular, it is essential to stop the operation of the wireless unit 117 with large power consumption. Furthermore, the fact that the communication unit 114 is out of commission due to low battery charge is displayed on the display unit 115.

That is, the operation of the communication unit 114 is prohibited by the voltage detector 116 and controller 112, and this fact can be displayed on the display unit 115. This display may be in the form of a character message, but an arrangement may be such that x is marked on a telephone icon displayed in an upper portion of the display surface of the display unit 115 as a more intuitive display.

By including a power-off unit 126 which can selectively disconnect power of a portion relating to the function of the communication unit 114, it is possible to reliably stop the function of the communication unit 114.

As heretofore described, according to the portable information device 110 of the embodiment, as it includes the piezoelectric vibrator 1 heightened in quality, it is also possible to achieve a heightening in quality of the portable information device itself in the same way. Furthermore, in addition to this, it is possible to display stable and high-accuracy timepiece information over a long period.

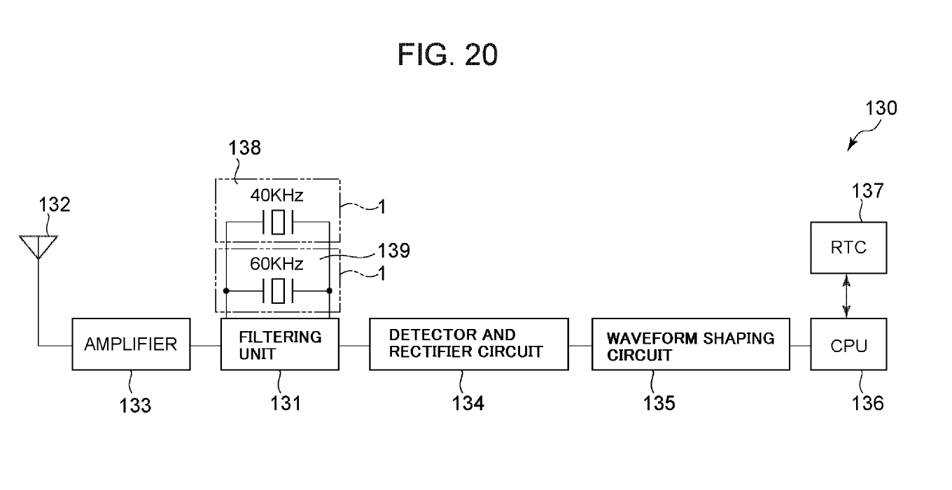

Next, a description will be given, with reference to FIG. 20, of one embodiment of an atomic timepiece according to the invention.

An atomic timepiece 130 of the embodiment, being one including the piezoelectric vibrator 1 electrically connected to a filtering unit 131, as shown in FIG. 20, is a timepiece which includes a function of receiving a standard electrical wave including timepiece information, makes an automatic correction to an accurate time, and displays it.

In Japan, there are transmitting stations which transmit standard electrical waves in Fukushima Prefecture (40 kHz) and Saga Prefecture (60 kHz), and each of them transmits a time calibration signal. As a long-frequency wave such as 40 kHz or 60 kHz has both a characteristic of propagating along the ground surface, and a characteristic of propagating while reflecting between the ionosphere and ground surface, its propagation range is wide, and the two transmitting stations encompass all Japan.

### Atomic Timepiece

Hereafter, a detailed description will be given of a functional configuration of the atomic timepiece 130.

An antenna 132 receives the time calibration signal with a long-frequency wave of 40 kHz or 60 kHz. The time calibration signal with the long-frequency wave is one wherein time information called a time code is amplitude-modulated into a 40 kHz or 60 kHz carrier wave. The received time calibration signal with the long-frequency wave is amplified by an amplifier 133, and filtered and tuned by the filtering unit 131 having a plurality of the piezoelectric vibrators 1.

The piezoelectric vibrators 1 of the embodiment include quartz oscillators 138 and 139 having resonance frequencies of 40 kHz and 60 kHz which are equal to the heretofore described carrier frequencies, respectively.

Furthermore, a filtered signal with a predetermined frequency is detected and demodulated by a detector and rectifier circuit 134.

Continuing, a time code is extracted via a waveform shaping circuit 135, and counted by a CPU 136. The CPU 136 reads information such as a current year, accumulated days, day, and time. The information read is reflected in an RTC 137, and accurate time information is displayed.

As the carrier wave is 40 kHz or 60 kHz, an oscillator having the heretofore described tuning fork shaped structure is suitable for the quartz oscillators 138 and 139.

The above description has been given with an example of Japan, but the frequency of the time calibration signal with the long-frequency wave is different in other countries. For example, in Germany, a time calibration signal of 77.5 kHz is used. Consequently, when the atomic timepiece 130 which can be used in other countries is built into a portable instrument, it requires another piezoelectric vibrator 1 with a frequency differing from that in the case of Japan.

As heretofore described, according to the atomic timepiece 130 of the embodiment, as it includes the piezoelectric vibrator 1 heightened in quality, it is also possible to achieve a heightening in quality of the atomic timepiece in the same way. Furthermore, in addition to this, it is possible to count time stably and with a high accuracy over a long period.

Heretofore, a detailed description has been given, with reference to the drawings, of the embodiments of the invention but, a specific configuration not being limited to these embodiments, a design change or the like without departing from the scope of the invention is also included therein.

For example, in the heretofore described embodiments, a description has been given taking the tuning fork shaped piezoelectric vibrating piece 5 as an example, but the invention is not limited to the tuning-fork shape. It is acceptable to use, for example, a thickness shear vibrating piece.

Also, in the heretofore described embodiments, a description has been given of a case in which the scribe lines M′ are formed on the outside end face 50b of the lid substrate wafer 50 in the breaking step, while the cutting blade 70 is pressed against the base substrate wafer 40 from the outside end face 40b thereof, but the invention is not limited to this. For example, it is acceptable that the scribe lines M′ are formed on the outside end face 40b of the base substrate wafer 40, while the cutting blade 70 is pressed against the lid substrate wafer 50 from the outside end face 50b thereof.

Furthermore, the recesses 3a may be formed in the base substrate wafer 40, or the recesses 3a may be formed in both wafers 40 and 50.

What is claimed is:

1. A method of cutting a glass wafer having a first surface and a second surface, comprising:
irradiating a laser onto the first surface of the wafer to form a groove in the first surface along a predetermined cutting line;
placing the first surface in contact with an elastic sheet; and
applying a stress with a cutting blade onto the second surface of the wafer along the predetermined cutting line to cut the wafer into sections along the predetermined cutting line.

2. The method according to claim 1, wherein the wafer consists of at least first and second glass substrates bonded together and has a thickness of about 0.4 mm to 0.9 mm.

3. The method according to claim 1, wherein the laser has a wavelength of 266 nm, the processing point power of the laser is set to 250 mW to 600 mW, the pulse energy thereof is set to 1000, the processing threshold fluence thereof is set to 30 J/(cm²·pulse), the scanning speed thereof is set to 40 mm/sec to 60 mm/sec, the aperture thereof is set to 10 mm, and the frequency thereof is set to around 65 kHz.

4. The method according to claim 1, wherein the groove is a “V” shaped groove having a width of about 14 μm and a depth of about 11 μm.

5. The method according to claim 1, wherein placing the first surface in contact with an elastic sheet comprises placing the first surface in contact with an elastic sheet via a separator having a thickness of about 20 μm to 30 μm.

6. The method according to claim 1, wherein the elastic sheet is made of silicon rubber.

7. The method according to claim 1, wherein the elastic sheet has a thickness of about 2 mm.

8. The method according to claim 1, wherein applying a stress with a cutting blade onto the second surface of the wafer comprises positioning the cutting blade along the predetermined cutting line under observation through the wafer by an image sensor located opposite to the cutting blade.

9. The method according to claim 1, wherein the cutting blade has an edge angle of about 60 degrees to about 90 degrees.

10. The method according to claim 1, wherein the stress by the cutting blade is about 10 kg/inch.

11. The method according to claim 1, further comprising placing the second surface of the wafer in contact with an adhesive sheet.

12. The method according to claim 11, wherein the adhesive sheet has a thickness of about 160 μm to 180 μm.

13. The method according to claim 11, further comprising expanding the adhesive sheet to separate the sections of the wafer.

14. The method according to claim 13, wherein the adhesive sheet is UV curable, and the method further comprises irradiating UV to the adhesive sheet to remove the separated sections of the wafer from the adhesive sheet.

15. The method according to claim 2, wherein the first substrate is defined with a plurality of lids for piezoelectric vibrator and the second substrate is defined with a plurality of bases therefor, and the method further comprises hermetically bonding, via a boding film, the first and second substrates such that at least some of the lids substantially coincide respectively with at least some of the bases, wherein between respective pairs of at least some of coinciding lids and bases, a cavity is formed in which a piezoelectric vibrating strip is placed.

16. The method according to claim 15, further comprising abrading the bonding film along the predetermined cutting line with a trimming laser.

17. The method according to claim 16, wherein the trimming laser has a wavelength of 532 μm, a diameter thereof is set to 10 μm to 30 μm, an average processing point power thereof is set to 1.0 W, a frequency modulation 20 kHz, and a scanning speed thereof is set to about 200 mm/sec.
